(19) United States
(12) Patent Application Publication
(10) Pub. No.: US 2018/0282162 A1
(43) Pub. Date: Oct. 4, 2018

(54) APPARATUS AND METHOD FOR MANUFACTURING GRAPHENE

(71) Applicant: Kuo-Chang Huang, Tainan City (TW)

(72) Inventor: Kuo-Chang Huang, Tainan City (TW)

(21) Appl. No.: 15/928,892

(22) Filed: Mar. 22, 2018

(30) Foreign Application Priority Data
Mar. 31, 2017 (TW) 106111102

(51) Int. Cl. C01B 32/186; C25F 3/02

(52) U.S. Cl. CPC C01B 32/186; B82Y 30/00; C25F 3/02

(57) ABSTRACT

An apparatus and a method for manufacturing graphene are provided. The apparatus includes a reaction chamber with a reaction space for performing chemical vapor deposition (CVD), a mold unit connected to the reaction chamber and a driving unit connected to the mold unit to rotate the mold unit relative to the reaction chamber. The mold unit includes a mold body that is disposed in the reaction space, is rotatable relative to the reaction chamber, and having an outer surface on which a graphene structure is to be formed.

### CROSS-REFERENCE TO RELATED APPLICATION

This application claims priority of Taiwanese Patent Application No.106111102, filed on Mar. 31, 2017.

### FIELD

The disclosure relates to an apparatus and a method for manufacturing graphene, and more particularly to an apparatus and a method for manufacturing graphene having a geometric structure.

### BACKGROUND

Graphene is an allotrope of carbon with great mechanical strength, elasticity, gas impermeability, and high thermal conductivity, and is nearly transparent. Due to these excellent intrinsic properties, in recent years, graphene has become a highly anticipated emerging material in industries, with heavy investments in research to explore its possible applications. At present, manufacture of graphene has reached a stage of mass production via a roll-to-roll process, which has a revolutionary impact on numerous industries.

The current optimal method for manufacturing graphene is chemical vapor deposition (CVD), in which a carbon source is cracked into reactive atomic carbon, and then the carbon is impinged and deposited on a substrate so as to generate high quality graphene. However, graphene produced by the current manufacturing method is limited to a two-dimensional sheet-like structure. Since graphene has excellent mechanical strength and elasticity, and since the manufactured sheet-like graphene structure is relatively thin, it remains a challenge to process the sheet-like graphene structure into a three-dimensional structure, e.g., tubular structure. Therefore, current applications of graphene are limited to using graphene having a sheet-like structure.

### SUMMARY

Therefore, an object of the disclosure is to provide an apparatus and a method for manufacturing graphene that can alleviate at least one of the drawbacks of the prior art.

According to one aspect of the disclosure, an apparatus for manufacturing graphene includes a reaction chamber, a mold unit and a driving unit. The reaction chamber defines a reaction space for performing chemical vapor deposition (CVD). The mold unit is connected to the reaction chamber, and includes a mold body. The mold body is disposed in the reaction space, is rotatable relative to the reaction chamber, and having an outer surface on which a graphene structure is to be formed. The driving unit is connected to the mold unit to rotate the mold body relative to the reaction chamber.

According to another aspect of the disclosure, a method for manufacturing graphene includes:

(a) providing a CVD system that includes a reaction chamber with a reaction space for performing CVD, and a mold unit that includes a mold body;

(b) forming a catalytic film on the mold body of the mold unit;

(c) mounting the mold unit on the reaction chamber such that the mold body with the catalytic film is disposed in the reaction space; and

(d) performing CVD and rotating the mold body along with the catalytic film relative to the reaction chamber during CVD, so that graphene is deposited on the catalytic film.

### BRIEF DESCRIPTION OF THE DRAWINGS

Other features and advantages of the present disclosure will become apparent in the following detailed description of the embodiment with reference to the accompanying drawing, of which:

FIG. 1 is a partly cross-sectional view illustrating an embodiment of an apparatus for manufacturing graphene according to the present disclosure;

FIGS. 2 to 4 are schematically sectional views illustrating deposition of graphene on a catalytic film on a mold body while the mold body is rotated;

FIG. 5 is a fragmentary sectional view illustrating graphene with a tubular structure formed on the catalytic film;

FIG. 6 is a flow chart showing an embodiment of a method for manufacturing graphene according to the present disclosure;

FIG. 7 illustrates steps of separating graphene from the mold body and transferring graphene onto another support; and

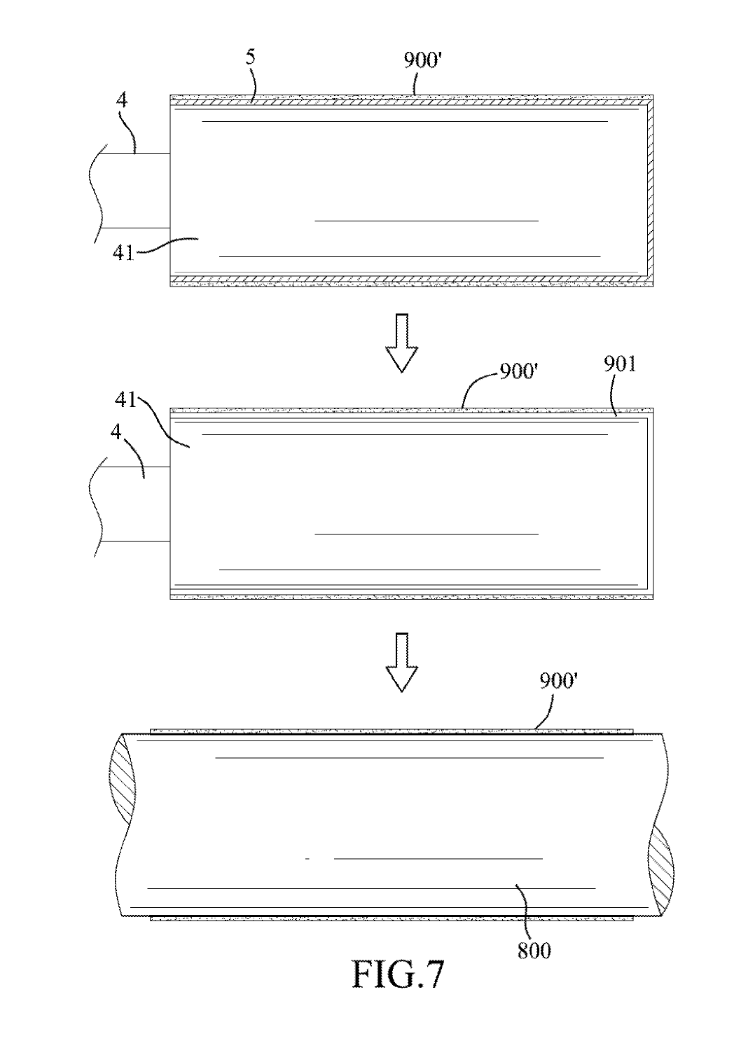

FIG. 8 is a fragmentary sectional view similar to FIG. 5, illustrating another type of the catalytic film of the present disclosure.

### DETAILED DESCRIPTION

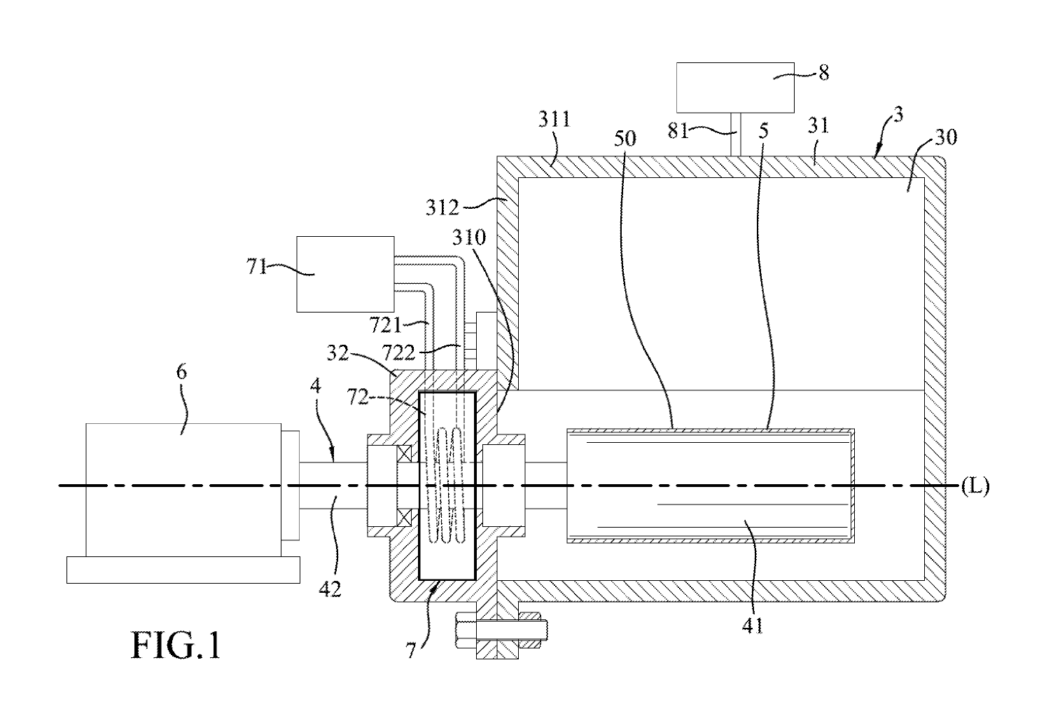

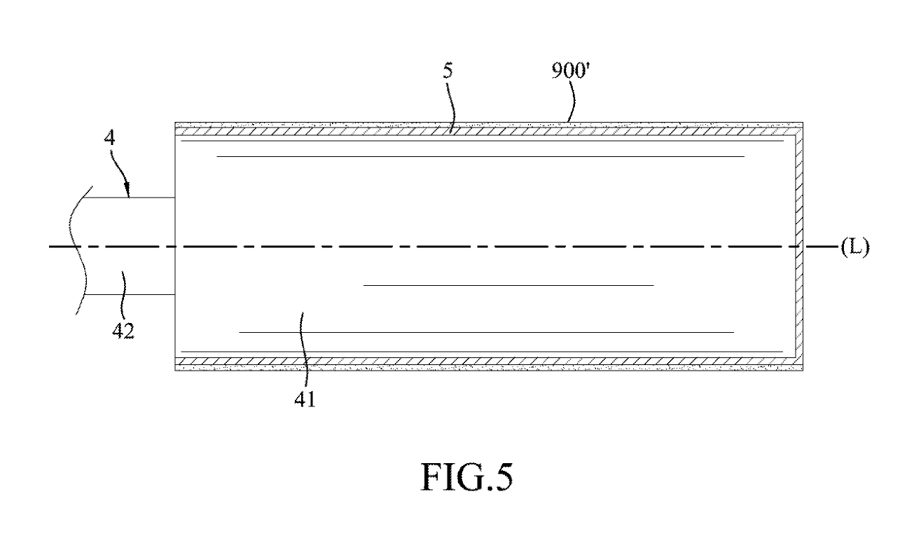

Before the disclosure is described in greater detail, it should be noted that where considered appropriate, reference numerals or terminal portions of reference numerals have been repeated among the figures to indicate corresponding or analogous elements, which may optionally have similar characteristics. Referring to FIGS. 1 and 5, an embodiment of an apparatus for manufacturing graphene according to the present disclosure includes a reaction chamber 3 that defines a reaction space 30 for performing chemical vapor deposition (CVD), a mold unit 4 that is connected to the reaction chamber 3 and a driving unit 6.

The reaction chamber 3 includes a chamber body 31 having an opening 310, and a cover body 32 detachably connected to the chamber body 31 so as to hermetically seal the opening 310. The chamber body 31 and the cover body 32 cooperatively define the reaction space 30.

The mold unit 4 is rotatably connected to the cover body 32 and is movable with the cover body 32. In this embodiment, the mold unit 4 includes a mold body 41 and a shaft 42. The mold body 41 is disposed in the reaction space 30, is rotatable relative to the reaction chamber 3 along a rotation axis (L), and has an outer surface on which graphene is to be formed. In this embodiment, the mold body 41 extends horizontally in the reaction space 30 along the rotation axis (L). The shaft 42 is connected to and extends coaxially and outwardly from the mold body 41 through the cover body 32 to engage with the driving unit 6. In certain embodiments, the shaft 42 is rotatably mounted on the cover body 32 so as to be rotatable relative to the cover body 32. Since various ways of rotatably mounting the shaft 42 on the cover body 32 are known to those skilled in the art, further details thereof are not provided herein for the sake of brevity.

Examples of a material suitable for making the mold body 41 and the shaft 42 in this disclosure may include, but not limited to, ceramic material, quartz material, etc. In this embodiment, the mold body 41 and the shaft 42 are made of a ceramic material.

The apparatus of the present disclosure further includes a catalytic film 5. The catalytic film 5 is used for facilitating graphene deposition during CVD. The catalytic film 5 is coated on the outer surface of the mold body 41 and is made of a metal material. Examples of the metal material of the catalytic film 5 suitable for use in this disclosure include nickel, copper, ruthenium, iridium, platinum, cobalt, palladium, gold, and combinations thereof. In this embodiment, the catalytic film 5 is made of copper. The catalytic film 5 may be fixedly coated on or detachably sleeved on the outer surface of the mold body 41 and is rotated with the mold body 41 relative to the reaction chamber 3. The thickness of the catalytic film 5 can be adjusted according to practical requirements, as long as the thickness is sufficient to allow graphene to be deposited thereon.

In certain embodiments, the mold body 41 may have a hollow tubular or solid columnar shape. In this embodiment, the mold body 41 has a solid columnar shape extending along the rotation axis (L) and has a circular cross-section perpendicular to the rotation axis (L). Thus, the catalytic film 5 coated thereon is in a tubular shape and has a radial cross-section of a circle so that graphene thus generated would be a tubular-shaped graphene structure 900′ with a radial cross-section of a circle. The cross-section of the mold body 41 may have other shapes, e.g., ellipse, polygon, etc. Thus, the catalytic film 5 in a tubular shape may also have a radial cross section of, e.g., ellipse, polygon, etc. In certain embodiments, the mold body 41 may be in a triangular columnar shape, square columnar shape, rectangular columnar shape, hexagonal columnar shape, or other elliptical columnar shapes. In certain embodiments, the mold body 41 may also be in a geometric shape, e.g., sphere, cone, pyramid, etc. Since the catalytic film 5 is coated on the outer surface of the mold body 41, the deposited graphene can be molded into the desired geometric structure, so as to generate the graphene structure 900′.

The driving unit 6 is connected to the mold unit 4 to rotate the mold body 41 relative to the reaction chamber 3. To be specific, the driving unit 6 is connected to the shaft 42 that is disposed outside of the reaction chamber 3. The driving unit 6 provides energy to rotate the shaft 42 and the mold body 41 so as to enable the catalytic film 5 to rotate relative to the reaction chamber 3 during CVD. In certain embodiments, the driving unit 6 is a motor.

The apparatus further includes a cooling unit 7. The cooling unit 7 associates with the cover body 32. To be specific, in this embodiment, the cooling unit 7 is provided in the cover body 32 and sleeves around the shaft 42 so as to dissipate thermal energy of the shaft 42 generated during rotation of the shaft 42. The cooling unit 7 may be a water cooling system or an air-cooling system. In certain embodiments, the cooling unit 7 is an air-cooling system that includes a cool air source 71 and a conduit 72 having an inlet 721 that connects to the cool air source 71 and an outlet 722 from which air absorbing the thermal energy generated during the rotation of the shaft 42 is discharged. It should be noted that the cooling unit 7 may be of any other cooling unit that can achieve cooling effect.

According to the present disclosure, the apparatus for manufacturing graphene further includes a source material supplying unit 8 that is used to generate and to supply a vaporized source material of graphene into the reaction chamber 3, a temperature control unit for controlling temperature in the reaction space 30, and a pressure control unit for controlling pressure in the reaction space 30. The source material supplying unit, the temperature control unit, the pressure control unit and the reaction chamber 3 constitute a CVD system. Since the source material supplying unit, the temperature control unit and the pressure control unit used in the CVD system are well known to those skilled in the art, further details thereof are not provided herein for the sake of brevity.

In this embodiment, the source material supplying unit 8 has an outlet 81 from which the vaporized source material is supplied into the reaction chamber 3. The rotation axis (L) and a deposition direction (i.e., a direction from the outlet 81 of the source material supplying unit 8 to the catalytic film 5) form a non-180-degree angle. In this embodiment, the chamber body 31 has a top wall 311 and a surrounding wall 312 extending inclinedly from the top wall 311. The cover body 32 is connected to the surrounding wall 312 and the rotation axis (L) passes through the surrounding wall 312. The vaporized source material is impinged at a direction from the top wall 311 to the catalytic film 5.

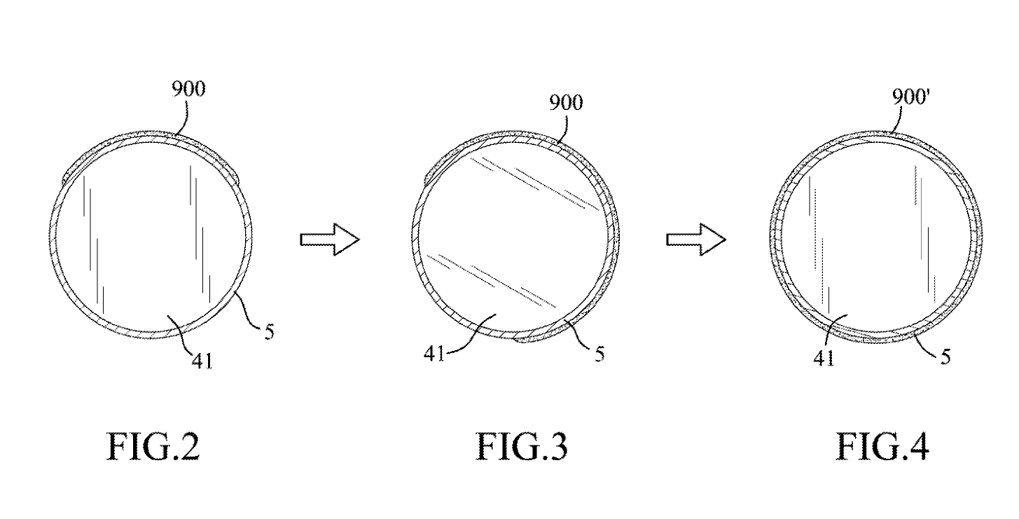

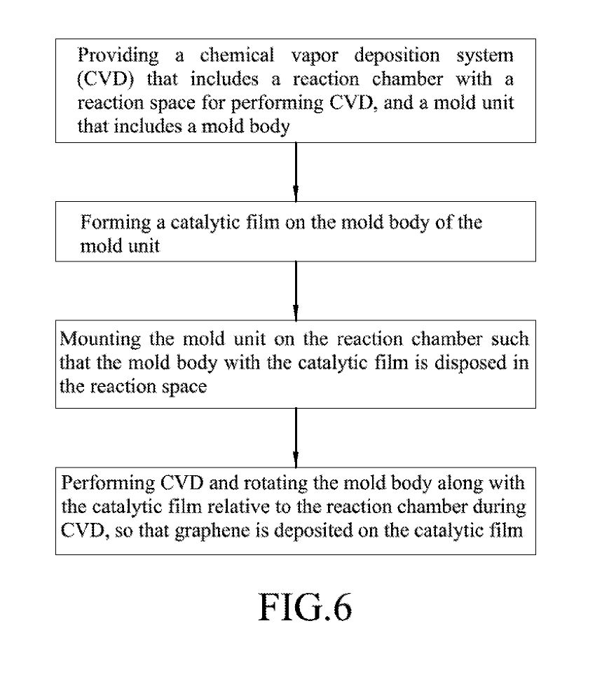

Referring to FIGS. 1, 2 to 4, and 6, an embodiment of a method for manufacturing graphene according to this disclosure includes the following steps:

Firstly, the CVD system that includes the reaction chamber 3 with the reaction space 30 for performing CVD, and the mold unit 4 that includes the mold body 41 are provided.

Then, the catalytic film 5 is formed on the mold body 41 of the mold unit 4.

The mold unit 4 is mounted on the reaction chamber 3 such that the mold body 41 with the catalytic film 5 is disposed in the reaction space 30.

After the mold unit 4 is assembled with the reaction chamber 3, CVD is performed and the mold body 41 along with the catalytic film 5 is rotated relative to the reaction chamber 3 via the driving unit 6. To be specific, based on the desired reaction conditions required for CVD, the temperature and the pressure in the reaction space 30 are controlled. The vaporized source material of graphene is delivered into the reaction space 30, and is impinged onto the mold body 41. On the mold body 41, the vaporized source material is decomposed and thus deposited on an upper portion of an outer peripheral surface 50 of the catalytic film 5 that faces the impinged vaporized source material so as to form a sheet-like graphene structure 900. During deposition of the sheet-like graphene structure 900, the driving unit 6 drives the mold unit 4 to rotate relative to the reaction chamber 3, so that the mold unit 4 drives the catalytic film 5 to rotate relative to the reaction chamber 3 at a predetermined rotation speed. The rotation of the catalytic film 5 allows other portions of the outer peripheral surface 50 of the catalytic film 5 to face the impinged vaporized source material, so that graphene is continuously deposited on the catalytic film 5 to gradually enlarge the area of the sheet-like graphene structure 900, and finally to form the tubular-shaped graphene structure 900′.

In this embodiment, the rotation speed is determined on the basis of the deposition rate of graphene. The deposition rate of graphene may be adjusted by changing the minimum spacing between the outer peripheral surface 50 of the catalytic film 5 and the outlet 81 of the source material supplying unit 8.

After CVD is completed (i.e., the desired graphene structure 900′ is formed on the catalytic film 5) and the graphene structure 900′ is subjected to an annealing procedure, the mold body 41 along with the catalytic film 5 is removed from the reaction chamber 3 and the graphene structure 900′ is separated from the catalytic film 5. To be specific, the cover body 32 and the mold unit 4 are removed from the reaction chamber 3. Next, the graphene structure 900′ is separated from the catalytic film 5. If the catalytic film 5 is fixedly coated on the mold body 41, separating the graphene structure 900′ from the catalytic film 5 may be conducted by electrochemical delamination or by etching the catalytic film 5 away from the graphene structure 900′, so that the graphene structure 900′ is separated from the mold body 41. If the catalytic film 5 is detachably sleeved on the mold body 41, the catalytic film 5 can be easily separated from the mold body 41 via an external force (e.g., mechanical force). It should be noted that, in practice, it may not be necessary to separate the graphene structure 900′ from the catalytic film 5.

In this embodiment, the graphene structure 900′ is in a tubular shape, and thus has an internal space 901 therein.

Afterward, the obtained graphene structure 900′ may be transferred and sleeved on another support 800.

The support 800 has a surface portion which may be made from, e.g., silicon dioxide (SiO₂), ethylene vinyl acetate (EVA), polyethylene terephthalate (PET), etc.

In certain embodiments, in addition to rotating the mold unit 4 relative to the reaction chamber 3 by the driving unit 6, an additional driving unit (not shown) may be mounted on the reaction chamber 3 so as to rotate the reaction chamber 3 relative to the mold unit 4 in a direction that is opposite to a rotating direction of the mold unit 4. Thus, the relative rotation speed between the mold unit 4 and the reaction chamber 3 can be enhanced, thereby improving the manufacturing speed of the graphene structure 900′.

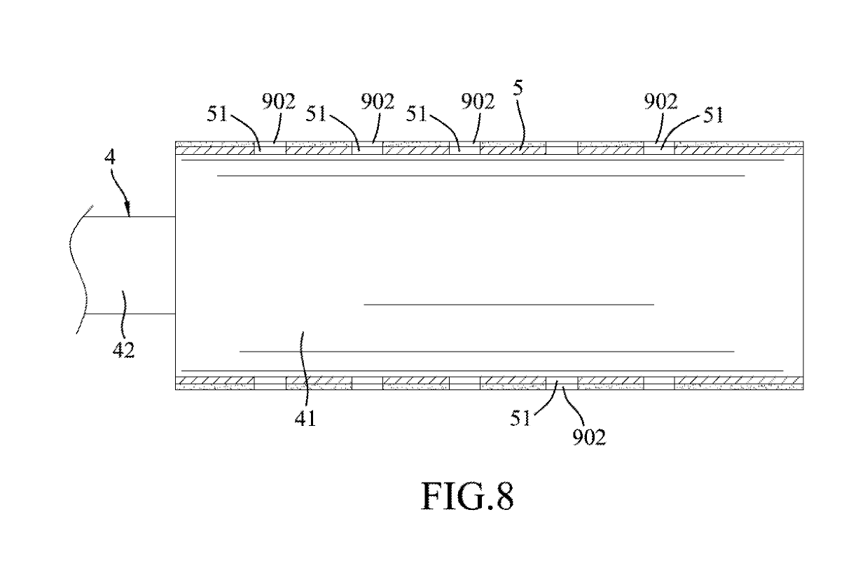

FIG. 8 shows another type of the catalytic film 5 of the present disclosure. To be specific, the catalytic film 5 is formed with at least one through hole 51 extending through an inner surface (contacting the mold body 41) and an outer surface of the catalytic film 5. In FIG. 8, the catalytic film 5 is formed with a plurality of through holes 51. The through holes 51 may be formed as geometric holes such as circular holes, polygonal holes, etc. Since vaporized source material cannot be deposited on the through holes 51 of the catalytic film 5, the graphene structure 900′ may be formed with a plurality of perforations 902 respectively corresponding to the through holes 51. In practice, the through holes 51 may be directly disposed on the catalytic film 5 based on the desired number and distribution of the perforations 902 of the graphene structure 900′ to be manufactured.

In summary, with the mold body 41 that is designed to be rotatable relative to the reaction chamber 3, the catalytic film 5 formed on the mold body 41 can also be rotatable during the CVD procedure, so that graphene with a three-dimensional geometric structure can be formed. The apparatus and method for manufacturing graphene of the present disclosure can greatly improve the application of graphene.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An apparatus for manufacturing graphene, comprising:
a reaction chamber that defines a reaction space for performing chemical vapor deposition (CVD);
a mold unit that is connected to said reaction chamber, and that includes a mold body disposed in said reaction space, is rotatable relative to said reaction chamber, and having an outer surface on which a graphene structure is to be formed; and
a driving unit that is connected to said mold unit to rotate said mold body relative to said reaction chamber.

2. The apparatus as claimed in claim 1, wherein said reaction chamber includes a chamber body having an opening, and a cover body detachably connected to said chamber body so as to hermetically seal said opening, said chamber body and said cover body cooperatively defining said reaction space, said mold unit being rotatably connected to said cover body and being movable with said cover body.

3. The apparatus as claimed in claim 2, wherein said mold unit further includes a shaft that is connected to and extends from said mold body through said cover body to engage with said driving unit.

4. The apparatus as claimed in claim 2, further comprising a cooling unit that is provided in said cover body and is sleeved on said shaft so as to dissipate thermal energy of said shaft generated during rotation of said shaft.

5. The apparatus as claimed in claim 1, further comprising a catalytic film that is coated on said outer surface of said mold body for facilitating graphene deposition during CVD process.

6. The apparatus as claimed in claim 5, wherein said catalytic film is formed with at least one through hole.

7. The apparatus as claimed in claim 5, wherein said catalytic film is fixedly coated on said outer surface of said mold body.

8. The apparatus as claimed in claim 5, wherein said catalytic film is detachably sleeved on said outer surface of said mold body.

9. The apparatus as claimed in claim 5, wherein said catalytic film is made from a material selected from the group consisting of nickel, copper, ruthenium, iridium, platinum, cobalt, palladium, gold, and combinations thereof.

10. The apparatus as claimed in claim 5, wherein said catalytic film is in a tubular shape.

11. The apparatus as claimed in claim 10, wherein said catalytic film has a cross section of circle.

12. The apparatus as claimed in claim 10, wherein said catalytic film has a cross section of ellipse.

13. The apparatus as claimed in claim 10, wherein said catalytic film has a cross section of polygon.

14. A method for manufacturing graphene, comprising:
(a) providing a CVD system that includes a reaction chamber with a reaction space for performing CVD, and a mold unit that includes a mold body;
(b) forming a catalytic film on the mold body of the mold unit;
(c) mounting the mold unit on the reaction chamber such that the mold body is disposed in the reaction space; and
(d) performing CVD and rotating the mold body along with the catalytic film relative to the reaction chamber during CVD, so that graphene is deposited on the catalytic film.

15. The method as claimed in claim 14, further comprising a step (e), after CVD is completed, removing the mold body along with the catalytic film from said reaction chamber and separating graphene from the catalytic film.

16. The method as claimed in claim 14, wherein, in step (e), separating graphene from the catalytic film is conducted by etching the catalytic film away from the graphene structure.

17. The method as claimed in claim 14, wherein, in step (e), separating graphene from the catalytic film is conducted by electrochemical delamination.
